(19) United States
(12) Patent Application Publication
(10) Pub. No.: US 2011/0209061 A1
(43) Pub. Date: Aug. 25, 2011

(54) METHOD FOR PLAYING BACK AUDIO FILES WITH AN AUDIO REPRODUCTION DEVICE

(75) Inventors: Carolina Burris, Malmo (SE); Johanna Ramström, Malmo (SE); Dan Sjögren, Loddekopinge (SE)

(73) Assignee: SONY ERICSSON MOBILE COMMUNICATIONS AB, Lund (SE)

(21) Appl. No.: 12/708,892

(22) Filed: Feb. 19, 2010

(51) Int. Cl. G06F 17/30; G06F 3/048; G06F 17/00

(52) U.S. Cl. 715/716; 707/E17.009; 707/769; 700/94; 707/E17.112; 715/748

(57) ABSTRACT

A method for playing back audio files with an audio reproduction device and an audio reproduction device are described.

The present invention relates to a method for playing back audio files with an audio reproduction device and an audio reproduction device utilizing the aforementioned method.

### BRIEF SUMMARY OF THE INVENTION

According to an embodiment, a method for playing back audio files with an audio reproduction device is provided. According to the method, a plurality of playlists and a plurality of playlist categories are provided. Each playlist of the plurality of playlists comprises at least one audio file identifier identifying an audio file. Each playlist is assigned to at least one of the plurality of playlist categories. The plurality of playlist categories is displayed to a user at the audio reproduction device. A first user selection selecting a playlist category from the displayed playlist categories is detected by the audio reproduction device. Based on the first user selection those playlists which are assigned to the selected playlist category are displayed at the audio reproduction device to the user. A second user selection selecting a playlist of the displayed playlists is detected by the audio reproduction device. Then, the audio files identified by the selected playlist are played back with the audio reproduction device.

The playlist categories may comprise training classes like for example spinning, body pump, jogging, step training, afro dance, and body combat. The playlists may comprise workout playlists comprising audio file identifiers of audio files which are adapted to be played back during a workout or training of the corresponding training class. Therefore, when a user of the audio reproduction device, for example a mobile MP3 player or a mobile phone adapted to play back audio files, wants to make some workout, the user simply has to specify the kind of workout the user wants to perform and gets in return from the audio reproduction device a list of suitable playlists for the specified workout category. Each of the playlists may contain additional information concerning for example the genre of music of the audio files listed in the playlist or a total playing time of the audio files listed in the playlist or concerning a workout structure or workout intensity the playlist is suitable for. After the user has selected an appropriate playlist from the displayed playlists, the audio files identified in the selected playlist are played back by the audio reproduction device. Therefore, the user does not have to compose appropriate playlists for a workout on his or her own, but can simply select from the predefined playlists.

For playing back the audio files identified by the selected playlist the audio reproduction device may retrieve audio files based on the audio file identifiers of the selected playlist and may play back the retrieved audio files. The audio files may be retrieved from a remote server or from a memory of the audio reproduction device.

According to another embodiment an audio reproduction device comprising a user interface and a processing unit is provided. The processing unit has access to a plurality of audio files, a plurality of playlists and a plurality of playlist categories. Each playlist of the plurality of playlists comprises at least one audio file identifier and each playlist is assigned to at least one of the plurality of playlist categories. The processing unit is adapted to display the plurality of playlist categories to a user and to detect a first user selection selecting a playlist category from the displayed playlist categories. Based on the first user selection the processing unit is adapted to display those playlists to the user which are assigned to the selected playlist category. Furthermore, the processing unit is adapted to detect a second user selection which selects a playlist of the displayed playlists. Based on the selected playlist the processing unit is adapted to play back the audio files identified by the selected playlist.

According to a further embodiment, the processing unit is adapted to retrieve the audio files based on the audio file identifiers of the selected playlist and to play back the retrieved audio files. The audio files may be retrieved from an external device, for example a server in the internet or in a communication network, via a communication connection. Furthermore, the audio reproduction device may comprise a storage device storing at least some of the audio files to be played back and the audio files may be retrieved from the storage device of the audio reproduction device. In the same way, the plurality of playlists or the plurality of playlist categories may be retrieved by the processing unit from an external device via a communication connection or from the internal storage device. The communication connection may be any kind of wired or wireless connection. A wired connection may be for example an internet connection or a telephone connection, whereas a wireless communication connection may comprise for example a WLAN, UMTS, GSM, or GPRS connection.

The audio reproduction device may comprise a mobile phone, a personal digital assistant, a mobile navigation system, a mobile music player or a mobile computer.

The playlist categories may comprise training classes comprising for example at least one of the following categories: spinning, body pump, jogging, step training, afro dance, and body combat.

Although specific features described in the above summary and the following detailed description are described in connection with specific embodiments, it is to be understood that the features of the embodiments described can be combined with each other unless it is noted otherwise.

### BRIEF DESCRIPTION OF THE SEVERAL VIEWS OF THE DRAWINGS

Hereinafter, exemplary embodiments of the invention will be described with reference to the drawings.

FIG. 1 shows an audio reproduction device according to an embodiment of the present invention.

FIG. 2 shows a flowchart of a method according to an embodiment of the present invention.

### DETAILED DESCRIPTION OF THE INVENTION

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise.

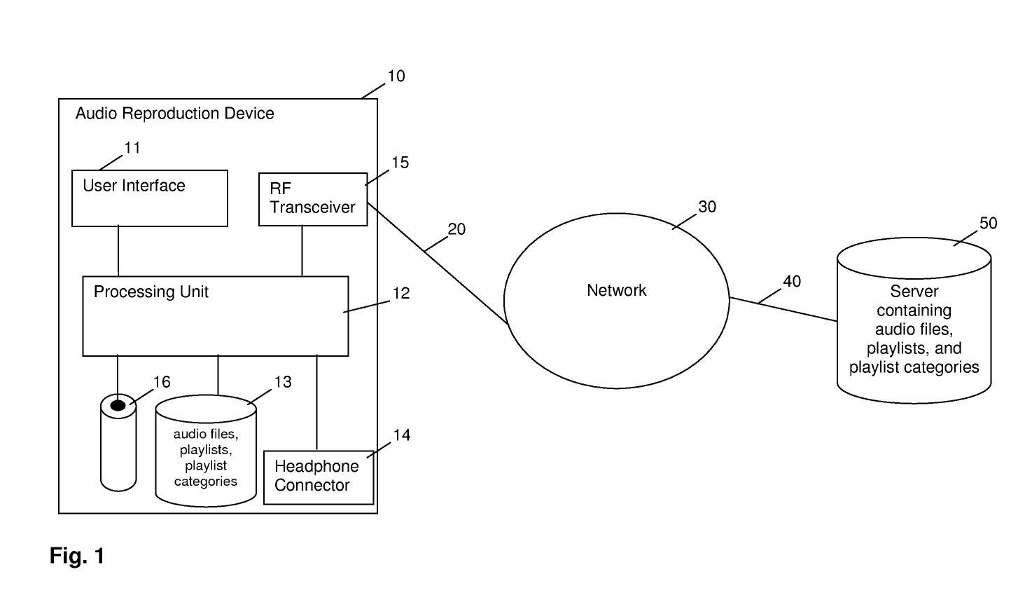

FIG. 1 shows schematically an audio reproduction device 10, which may be a mobile phone, a personal digital assistant, a mobile navigation system, a mobile music player or a mobile computer. Furthermore, an environment for the audio reproduction device 10 is shown in FIG. 1. However, although the present invention is described in connection with the environment shown in FIG. 1, this environment is shown for illustrative purposes only and the audio reproduction device 10 may be used in any other environment or may be used stand-alone.

The audio reproduction device 10 comprises a user interface 11, a processing unit 12, a memory 13, a headphone connector 14, a radio frequency transceiver 15 and a battery 16. Additionally, the audio reproduction device 10 may comprise additional components, for example a loudspeaker, a microphone and so on, but these components are not shown in the figure to simplify matters. The processing unit 12 is connected to the user interface 11, the headphone connector 14, the memory 13, and the radio frequency transceiver 15. The processing unit 12 and all other components of the audio reproduction device 10 are powered by the battery 16, which may be a rechargeable battery.

The audio reproduction device 10 may be connected to a server 50 via a communication network 30. A connection 20 between the audio reproduction device 10 and the network 30 may be a wireless connection, for example a GSM, UMTS, GPRS, WLAN, or a Bluetooth connection. However, connection 20 may be any other kind of wireless or wired connection. Connection 40 between the network 30 and the server 50 may also be any kind of wireless or wired connection.

The radio frequency transceiver 15 may utilize data communication between the processing unit 12 and the server 50 via the connection 20, the network 30 and the connection 40. The server 50 and the memory 13 may contain audio files, playlists, and playlist categories. Thus, the processing unit has access to audio files, playlists, and playlist categories locally to the memory 13 and remotely to the server 50.

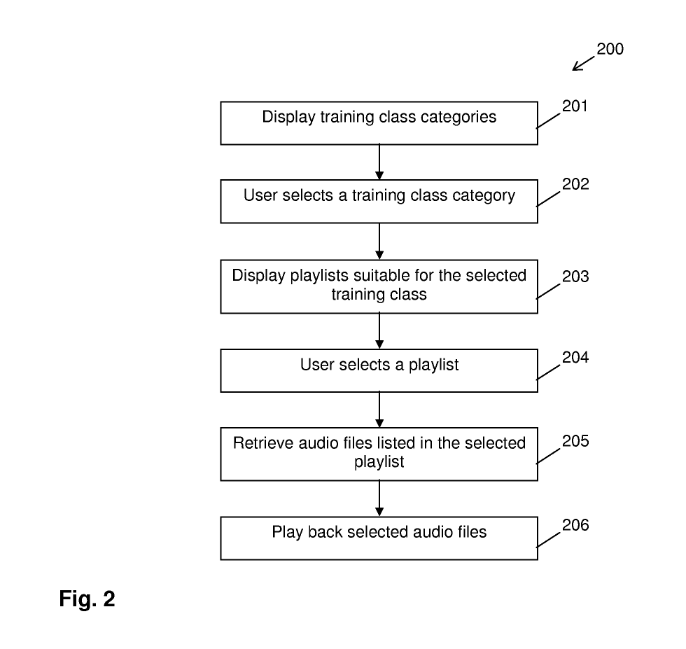

Operation of the processing unit 12 will now be described in more detail in connection with a user scenario and by referencing FIG. 1 and FIG. 2.

When a user of the audio reproduction device 10, for example a mobile phone, wants to make some training or workout, the user might want to listen to music being played back by the audio reproduction device 10 during workout. Furthermore, the user may want to listen to music which is adapted to the kind of workout the user is planning to do. The kind of workout may be for example spinning, body pump, jogging, step up, afro dance, body combat and so on. Therefore, the music should be adapted in relation to speed, loudness, genre and so on to the kind of workout the user is planning to do. Furthermore, the music should be adapted to the different phases of the workout, for example a warm up phase, phases of varying intensity, and a cool down phase.

Instead of composing an appropriate playlist on his or her own, according to the present invention the user activates the audio reproduction device to perform the method 200 shown in FIG. 2.

According to method 200 the audio reproduction device 10 displays in a first step 201 several training class categories on the user interface 11 of the audio reproduction device 10. The training class categories may be retrieved by the processing unit 12 via the radio frequency transceiver 15 and the network 30 from the remote server 50 containing several playlist categories or may be retrieved from the internal memory 13. In a next step 202 the user selects one of the displayed training class categories via the user interface 11 of the audio reproduction device 10. Upon this selection the processing unit 12 retrieves playlists suitable for the selected training class from the server 50 or from the internal memory 13. The retrieved playlists are displayed on the user interface 11 to the user (step 203). The displayed playlists may comprise for example a description and additional information informing the user about the contents of the audio files referenced in each playlist. The information may contain for example a total playing time of the audio files of the playlist, the genre of the audio files, a workout intensity the playlist is suitable for, and so on. In step 204 the user selects one of the playlists displayed on the user interface 11 of the audio reproduction device 10. Upon the playlist selection the processing unit 12 retrieves in step 205 the audio files listed in the selected playlist. The audio files may be retrieved from the internal memory 13 or via the network 30 from the server 50 or from several servers 50 in a data communication network. To reduce cost and transmission capacity the processing unit 12 may prefer retrieving the audio files from the internal memory 13. Furthermore, the processing unit 12 may request an acknowledgement from the user before downloading audio files from the server 50 via the network 30. Finally, the retrieved audio files of the selected playlists are played back by the audio reproduction device 10 in step 206.

It is to be understood that playing back audio files in step 206 may be performed in parallel to retrieving the audio files from the internal memory 13 or via the network 30 from the server 50 in step 205. Furthermore, it is to be understood that the server 50 may comprise several servers providing the information required. The server 50 may comprise for example an internet server accessible via an internet protocol communicated along a wired or wireless network 30. Furthermore, the server may comprise a server in a telecommunication network accessible via specific protocols, for example UMTS, GSM, GPRS and so on.

While exemplary embodiments have been described above, various modifications may be implemented in other embodiments. For example, the training class categories displayed to the user in step 201 may also comprise a training intensity to restrict the number of suitable playlists being displayed to the user in step 203.

Finally, it is to be understood that all the embodiments described above are considered to be comprised by the present invention as it is defined by the appended claims.

What is claimed is:

1. A method for playing back audio files with an audio reproduction device, the method comprising:
providing a plurality of playlists, wherein each playlist of the plurality of playlists comprises at least one audio file identifier,
providing a plurality of playlist categories, wherein each playlist is assigned to at least one of the plurality of playlist categories,
displaying at the audio reproduction device the plurality of playlist categories to a user,
detecting at the audio reproduction device a first user selection selecting a playlist category from the displayed playlist categories,
displaying at the audio reproduction device the playlists which are assigned to the selected playlist category to the user,
detecting at the audio reproduction device a second user selection selecting a playlist of the displayed playlists, and
playing back audio files identified by the selected playlist with the audio reproduction device.

2. The method according to claim 1, wherein the step of playing back the audio files identified by the selected playlist comprises retrieving audio files based on the audio file identifiers of the selected playlist and playing back the retrieved audio files.

3. The method according to claim 1, wherein the playlist categories comprise training classes.

4. The method according to claim 3, wherein the training classes comprise at least one of the group comprising spinning, body pump, jogging, step training, afro dance, and body combat.

5. An audio reproduction device, comprising a user interface and a processing unit having access to a plurality of audio files, a plurality of playlists, and a plurality of playlist categories, wherein each playlist of the plurality of playlists comprises at least one audio file identifier and wherein each playlist is assigned to at least one of the plurality of playlist categories, wherein the processing unit is adapted to:
display the plurality of playlist categories to a user,
detect a first user selection selecting a playlist category from the displayed playlist categories,
display the playlists which are assigned to the selected playlist category to the user,
detect a second user selection selecting a playlist of the displayed playlists, and
play back audio files identified by the selected playlist.

6. The audio reproduction device according to claim 5, wherein for playing back the audio files identified by the selected playlist the processing unit is adapted to retrieve the audio files based on the audio file identifiers of the selected playlist and to play back the retrieved audio files.

7. The audio reproduction device according to claim 6, wherein the processing unit is adapted to retrieve the audio files from an external device via a communication connection.

8. The audio reproduction device according to claim 6, wherein the audio reproduction device comprises a storage device storing at least some of the audio files to be played back, and wherein the processing unit is adapted to retrieve the audio files from the storage device.

9. The audio reproduction device according to claim 5, wherein the processing unit is adapted to retrieve the plurality of playlists from an external device via a communication connection.

10. The audio reproduction device according to claim 5, wherein the processing unit is adapted to retrieve the plurality of playlist categories from an external device via a communication connection.

11. The audio reproduction device according to claim 5, wherein the playlist categories comprise training classes.

12. The audio reproduction device according to claim 11, wherein the training classes comprise at least one of the group comprising spinning, body pump, jogging, step training, afro dance, and body combat.

13. The audio reproduction device according to claim 5, wherein the audio reproduction device comprises a device selected from the group comprising a mobile phone, a personal digital assistant, a mobile navigation system, a mobile music player and a mobile computer.
